(19) United States
(12) Patent Application Publication
(10) Pub. No.: US 2025/0070212 A1
(43) Pub. Date: Feb. 27, 2025

(54) ASSEMBLY COMPRISING A STACK OF SOEC/SOFC SOLID OXIDE CELLS AND OUTER GUIDING ELEMENTS

(71) Applicant: COMMISSARIAT A L'ENERGIE ATOMIQUE ET AUX ENERGIES ALTERNATIVES, Paris (FR)

(72) Inventors: Stéphane DI IORIO, Grenoble Cedex 09 (FR); Thibault MONNET, Grenoble Cedex 09 (FR); Bastien GERVASONI, Grenoble Cedex 09 (FR); Olivier GILLIA, Grenoble Cedex 09 (FR); Karl VULLIEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/729,057

(22) PCT Filed: Jan. 12, 2023
(86) PCT No.: PCT/FR2023/050044

§ 371 Date: Jul. 15, 2024

(30) Foreign Application Priority Data
Jan. 17, 2022 (FR) FR2200370

(51) Int. Cl. H01M 8/248; C25B 9/77; C25B 13/02; H01M 8/0256; H01M 8/12; H01M 8/2404; H01M 8/2432

(52) U.S. Cl. CPC H01M 8/248; C25B 9/77; C25B 13/02; H01M 8/0256; H01M 8/2404; H01M 8/2432; H01M 2008/1293

(57) ABSTRACT

An assembly includes a stack of SOEC/SOFC solid oxide cells, the stack having a plurality of plates stacked one on top of the other, each plate having an outer lateral surface, the plurality of plates including at least a plurality of electrochemical cells, a plurality of interconnectors, and upper and lower end plates. At least two guiding elements are configured to guide the vertical stacking of at least some of the plates of the stack. The at least two guiding elements extend vertically in a vertical direction and bear against the outer lateral surface of each of the at least some of the plates.

### TECHNICAL FIELD

The present invention relates to the general field of high-temperature electrolysis (HTE), in particular high-temperature steam electrolysis (HTSE), respectively referred to by the English names “High-Temperature Electrolysis” (HTE) and “High-Temperature Steam Electrolysis” (HTSE), carbon dioxide (CO2) electrolysis, or steam and carbon dioxide (CO2) high-temperature co-electrolysis.

More specifically, the invention relates to the field of high-temperature solid-oxide electrolysers, usually referred to by the acronym SOEC (standing for “Solid-Oxide Electrolysis Cell” in English).

It also relates to the field of high-temperature solid-oxide fuel cells, usually referred to by the acronym SOFC (standing for “Solid-Oxide Fuel Cells” in English).

Thus, more generally, the invention relates to the field of SOEC/SOFC-type solid-oxide stacks operating at high temperature.

More specifically, the invention relates to an assembly including a SOEC/SOFC-type solid-oxide cells stack and inner guiding elements, as well as an associated conditioning process.

### PRIOR ART

In the context of a SOEC-type high-temperature solid-oxide electrolyser, steam (H₂O) is transformed into dihydrogen (H₂) and dioxygen (O₂), and/or carbon dioxide (CO₂) is transformed into carbon monoxide (CO) and dioxygen (O₂) by means of an electric current, within the same electrochemical device. In the context of a SOFC-type high-temperature solid-oxide fuel cell, the operation is reversed to produce an electric current and heat by being supplied with dihydrogen (H₂) or other fuels such as methane (CH₄), natural gas, biogas, and with dioxygen (O₂), typically with air. For simplicity, the following description favours the operation of a SOEC-type high-temperature solid-oxide electrolyser carrying out the electrolysis of steam. Nonetheless, this operation is applicable to the electrolysis of carbon dioxide (CO₂), or to the co-electrolysis of steam at high temperature with carbon dioxide (CO₂). In addition, this operation can be transposed to the case of a SOFC-type high-temperature solid-oxide fuel cell.

In order to carry out the electrolysis of water, it is advantageous to carry it out at high temperature, typically between 600 and 1,000° C., because it is more advantageous to electrolyse steam than liquid water and because part of the energy necessary for the reaction could be supplied by heat, less expensive than electricity.

To implement the high-temperature steam electrolysis (HTSE), a SOEC-type high-temperature solid-oxide electrolyser consists of a stack of elementary units each including a solid-oxide electrolysis cell, or an electrochemical cell, consisting of three anode/electrolyte/cathode layers superposed on top of one another, and interconnection plates made of metal alloys, also called bipolar plates or interconnectors. Each electrochemical cell is sandwiched between two interconnection plates. A SOEC-type high-temperature solid-oxide electrolyser is then an alternating stack of electrochemical cells and interconnectors. A SOFC-type high-temperature solid-oxide fuel cell consists of the same type of stack of elementary units. This high-temperature technology being reversible, the same stack can operate in the electrolysis mode and produce hydrogen and oxygen from water and electricity, or in the fuel cell mode and produce electricity from hydrogen and oxygen.

Each electrochemical cell corresponds to an electrolyte/electrode assembly, which is typically a multilayer ceramic assembly the electrolyte of which is formed by an ion-conducting central layer, this layer being solid, dense and sealed, and sandwiched between the two porous layers forming the electrodes. It should be noted that additional layers may exist, but which only serve to improve one or more of the layers already described.

The electrical and fluidic interconnection devices are electronic conductors which ensure, from an electrical viewpoint, the connection of each elementary unit electrochemical cell in the stack of elementary units, guaranteeing electrical contact between one face and the cathode of a cell and between the other face and the anode of the next cell, and from a fluidic viewpoint, the supply of reagents and the discharge of the products for each of the cells. Thus, the interconnectors ensure the functions of supplying and collecting an electrical current and delimit gas circulation compartments, for distribution and/or collection.

More specifically, the main function of the interconnectors is to ensure the passage of the electric current but also the circulation of the gases in the vicinity of each cell (namely: injected steam, hydrogen and oxygen extracted for the HTE electrolysis; air and fuel including the injected hydrogen and extracted water for a SOFC cell), and to separate the anode and cathode compartments of two adjacent cells, which are the gas circulation compartments on the side of the anodes and cathodes of the cells, respectively.

In particular, for a SOEC-type high-temperature solid-oxide electrolyser, the cathode compartment includes steam and hydrogen, produced from the electrochemical reaction, whereas the anode compartment includes a draining gas, if present, and oxygen, another product of the electrochemical reaction. For a SOFC-type high-temperature solid-oxide fuel cell, the anode compartment includes the fuel, whereas the cathode compartment includes the fuel.

To carry out the high-temperature steam electrolysis (HTE), steam (H₂O) is injected into the cathode compartment. Under the effect of the electric current applied to the cell, the dissociation of the water molecules in the form of steam is carried out at the interface between the hydrogen electrode (cathode) and the electrolyte: this dissociation produces dihydrogen gas (H₂) and oxygen ions (O²⁻). The dihydrogen (H₂) is collected and discharged at the outlet of the hydrogen compartment. The oxygen ions (O²⁻) migrate through the electrolyte and recombine into dioxygen (O₂) at the interface between the electrolyte and the oxygen electrode (anode). A draining gas, such as air, can circulate at the anode and thus collect the oxygen generated in gaseous form at the anode.

To ensure the operation of a solid-oxide fuel cell (SOFC), air (oxygen) is injected into the cathode compartment of the cell and hydrogen into the anode compartment. The oxygen of the air will dissociate into O²⁻ ions. These ions will migrate in the electrolyte from the cathode towards the anode to oxidise the hydrogen and form water with simultaneous production of electricity. In an SOFC cell, like in a SOEC electrolysis, the steam is in the dihydrogen compartment (H₂). Only the polarity is reversed.

For illustration, FIG. 1 shows a schematic view showing the operating principle of a SOEC-type high-temperature solid-oxide electrolyser. The function of such an electrolyser is to transform steam into hydrogen and oxygen according to the following electrochemical reaction:

2H₂O→2H₂+O₂.

This reaction is carried out electrochemically in the cells of the electrolyser. As schematically shown in FIG. 1, each elementary electrolysis cell 1 is formed of a cathode 2 and an anode 4, placed on either side of a solid electrolyte 3. The two electrodes (cathode and anode) 2 and 4 are electronic and/or ionic conductors, made of a porous material, and the electrolyte 3 is gas-tight, an electronic insulator and an ion conductor. In particular, the electrolyte 3 may be an anionic conductor, more specifically an anionic conductor of the O²⁻ ions and the electrolyser is then so-called an anionic electrolyser, in contrast with proton electrolytes (H⁺).

The electrochemical reactions take place at the interface between each of the electronic conductors and the ionic conductor.

At the cathode 2, the half-reaction is as follows:

2H₂O+4e⁻→2H₂+2O²⁻.

At the anode 4, the half-reaction is as follows:

2O²⁻→O₂+4e⁻.

The electrolyte 3, interposed between the two electrodes 2 and 4, is the site of migration of the O²⁻ ions under the effect of the electric field created by the potential difference imposed between the anode 4 and the cathode 2.

As illustrated between brackets in FIG. 1, the steam at the cathode inlet may be accompanied by hydrogen H₂ and the hydrogen produced and recovered at the outlet may be accompanied by steam. Similarly, as illustrated in dotted lines, a draining gas, such as air, may also be injected at the anode-side inlet to discharge the produced oxygen. An additional function of the injection of a draining gas is to act as a thermal regulator.

An elementary electrolyser, or electrolysis reactor, consists of an elementary cell as described hereinabove, with a cathode 2, an electrolyte 3, and an anode 4, and two interconnectors which ensure the electrical and fluidic distribution functions.

To increase the flow rates of produced hydrogen and oxygen, it is known to stack several elementary electrolysis cells on top of one another while separating them by interconnectors. The assembly is positioned between two end interconnection plates which support the electric power supplies and the gas supplies of the electrolyser (electrolysis reactor).

Thus, a SOEC type high-temperature solid-oxide electrolyser comprises at least one, generally several, electrolysis cell(s) stacked on top of one another, each elementary cell being formed of an electrolyte, a cathode and an anode, the electrolyte being interposed between the anode and the cathode.

As indicated before, the fluidic and electrical interconnection devices which are in electrical contact with one or more electrode(s) generally ensure the electric current supply and collection functions and delimit one or more gas circulation compartment(s).

Thus, the function of the so-called cathode compartment is the distribution of the electric current and of the steam as well as the recovery of hydrogen at the cathode in contact.

The function of the so-called anode compartment is the distribution of the electric current as well as the recovery of the oxygen produced at the anode in contact, possibly with the help of a draining gas.

FIG. 2 shows an exploded view of elementary units of a SOEC-type high-temperature solid-oxide electrolyser according to the prior art. This electrolyser includes a plurality of elementary electrolysis cells C1, C2, of the solid-oxide cell (SOEC) type, stacked alternately with interconnectors 5. Each cell C1, C2 consists of a cathode 2.1, 2.2 and of an anode (only the anode 4.2 of the cell C2 is shown), between which an electrolyte is arranged (only the electrolyte 3.2 of the cell C2 is shown).

The interconnector 5 is a component made of a metal alloy which ensures separation between the cathode 50 and anode 51 compartments, defined by the volumes comprised between the interconnector 5 and the adjacent cathode 2.1 and between the interconnector 5 and the adjacent anode 4.2, respectively. It also ensures the distribution of the gases to the cells. The injection of steam into each elementary unit is done in the cathode compartment 50. The collection of the produced hydrogen and of the residual steam at the cathode 2.1, 2.2 is performed in the cathode compartment 50 downstream of the cell C1, C2 after dissociation of the steam by the latter. The collection of the oxygen produced at the anode 4.2 is performed in the anode compartment 51 downstream of the cell C1, C2 after dissociation of the steam by the latter. The interconnector 5 ensures the passage of the current between the cells C1 and C2 by direct contact with the adjacent electrodes, i.e. between the anode 4.2 and the cathode 2.1.

In order to guarantee good electrical contact between all of the interconnectors, the electrochemical cells and the interconnectors are sandwiched between two rigid plates, so-called the upper end plate and the lower end plate, electrically isolated from the interconnectors. The sandwich thus formed is so-called “stack”, and thus corresponds to the assembly comprising the upper and lower end plates, the electrochemical cells and the interconnectors. This stack should be kept under a compressive force to ensure good electrical continuity of the contact planes between the plates.

During the first phase of manufacture of the stacks, it is proceeded with the formation of the vitroceramic seal by subjecting the stack to a thermal cycle while applying a controlled compressive force on the stack. This thermal cycle is called the conditioning cycle.

Indeed, the various sealings between the circuits are ensured by seals made of molten glass. This molten glass is obtained by deposition of slip, a glass precursor. The slip is deposited in the form of beads sandwiched between the interconnection plates (or interconnectors). Afterwards, this slip dries in place to create a bead made of glass powders. Thus, when cold, before the temperature rise cycle which will form the glass, the interconnection plates are separated by dried slip beads. These beads will melt down during the heating cycle, and the contacts will be established at the previously-described reactive areas. Melting of the beads may result in a reduction of the thickness of the slip bead by more than 50%. These beads may also be made of already densified glass, sandwiched between two successive interconnectors of the stack. Just like during the conditioning cycle with dried slip beads, the meltdown of the glass seal will cause the shrinkage of the space between the interconnectors, but to a lesser extent than with slip.

In any case, it is important to ensure guidance according to a direction perpendicular to the plane of the interconnectors, or collinear with the direction of the compressive force of the interconnection plates and of the end plates. Such guidance allows guaranteeing that, during the shrinkage of the stack, which occurs during the formation of the glass, the constituent parts of the stack (in particular the interconnectors, the insulating plates, the end plates) remain correctly aligned with respect to one another. During this phase, the height of the stack decreases by practically 50% and thus results in a considerable vertical movement of the stack.

The development of industrial systems incorporating high-temperature electrolysers involves an increase in the volume of gas treated (in SOEC or SOFC). To do so, the increase in the surface area, the number of cells and of interconnectors, is necessary. Yet, a significant increase in the number of plates and therefore in the height of the stacks poses numerous technical difficulties, in particular during the manufacturing phases. Indeed, the larger the height of the stacks, the more critical the control of the guidance will be.

In current designs, this guidance is ensured by cylindrical columns positioned inside the structure of the stack passing through the different plates in which cylindrical or oblong holes are machined tightly matching the diameter of the columns. The base of these columns is mechanically blocked in the lower end plate.

This type of device has various limitations related to the small diameters of the guiding columns imposed by the inner structure of the interconnectors. Obtaining a satisfactory guidance of numerous thin plates over large heights by this type of columns involves a fine control of the relative clearances between the columns and the diameters of the passage holes. This type of assembly with tight clearances exposes to the risk of off-centring upon rotation which might occur during the cycle of formation of the sealing vitroceramic, during which the stack experiences a significant shrinkage of its height. It should be noted that the force applied to ensure the contact of the different plates is not so great, and therefore any inadvertent jamming of the plates with respect to their guiding elements is problematic. In addition, this type of guidance also involves operations of cutting the columns that protrude from the stack after conditioning, which cannot be dismounted after the thermal cycle and remain within the stack.

For illustration, FIGS. 3A and 3B show the current guiding solution. Two columns 11 and 12 are used to guide the plates P of the stack 20 (herein shown very schematically) in their descent. The plates P may consist of interconnection plates, insulating plates, or the lower and upper end plates. In this case, in FIG. 3B, it is considered, for example, that the upper and lower end plates P are shown, the other plates P sandwiched between these are therefore not shown. On one side, an orifice O1 with circular-shaped section is used, and the adjustment between the plate P and the column 11 is very fine, for example with a clearance J1 in the range of 0.1 mm. On the other side, the orifice O2 in the plate P has an oblong shaped section, leaving a larger clearance J2. Then, pressing at the centre to make the plates P descend, like according to the arrows F, as the vitroceramic seals are melted, might cause a slight bending of these plates P, and thus cause blocking by off-centring, represented by AC in FIG. 3B, on the column 11 on which the adjustment is tightened. In practice, in order to avoid these risks of off-centring AC, the clearance J1 around the guiding column 11 can be considerably increased, which then fundamentally degrades the guidance function and is therefore undesirable.

Thus, there is a need to propose an effective guiding solution allowing avoiding this off-centring problem while preserving guiding accuracy during the shrinkage of the stack of plates.

### DISCLOSURE OF THE INVENTION

The invention aims to at least partially address the aforementioned needs and the drawbacks relating to the embodiments of the prior art.

Thus, an object of the invention, according to one of its aspects, is an assembly including:
a stack of SOEC/SOFC-type solid-oxide cells operating at high temperature, consisting of a plurality of plates stacked on top of one another according to a vertical direction substantially perpendicular to each horizontal plane of extent of each plate, each plate including an upper surface, a lower surface and an outer lateral surface, said plurality of plates including at least:
   a plurality of electrochemical cells each formed by a cathode, an anode and an electrolyte interposed between the cathode and the anode, and a plurality of interconnectors each arranged between two adjacent electrochemical cells,
   an upper end plate and a lower end plate, between which the plurality of electrochemical cells and the plurality of interconnectors are sandwiched,
at least two guiding elements ensuring guidance into a vertical stack of at least part of the plates of the stack,
   characterised in that said at least two guiding elements extend vertically according to the vertical direction bearing against the outer lateral surface of each plate of said at least part of the plates.

The assembly according to the invention may further include one or more of the following features considered separately or according to any technical-feasible combination.

In particular, each horizontal plane is defined by horizontal directions perpendicular to one another.

Said at least two guiding elements may be fastened by means of a fastening device to a lower support plate on which the stack is placed and/or to an upper support plate under which the stack is placed.

The fastening device may include a fastening base, secured to the lower support plate and/or to the upper support plate, a compressive elastic return member, one end of which is in contact with a guiding element and the other end is in contact with the fastening base, and a fastening screw mounted on the base.

The compressive elastic return member may be made of a metal alloy, in particular of a metal superalloy, in particular nickel-based, for example made of Inconel® 718 or 750, or Haynes® 230®, or made of ceramic, for example by additive manufacturing, inter alia.

In addition, each guiding element may include a support device cooperating with the fastening device, including in particular at least one support plane of the compressive elastic return member and a support base in contact with the lower support plate and/or the upper support plate.

Furthermore, said at least two guiding elements may have at least partially a substantially cylindrical shape and may have, in cross-section with respect to the vertical direction, a substantially circular, triangular, triangular and semi-circular, square and/or rectangular shape.

In addition, said at least two guiding elements, in particular having a rectangular-shaped section, may be evenly distributed around each plate, in particular with the same number of guiding elements per face of each plate. Said at least two guiding elements may be present in a number equal to at least 4, or 6, or 8, or more, and in particular an even number. In this case of 4 guiding elements, these may be positioned at the centre with respect to each face of the plate. In the case of 8 guiding elements, two guiding elements may be positioned on either side of each angle of a plate with four corners.

Moreover, each plate of said at least part of the plates may include at least two notches formed over the lateral surface of the plate in which said at least two guiding elements, in particular circular, oval or “V”-like shaped, bear.

Each notch of at least part of the notches may have a “V”-like shape obtained by forming two planes tangent on the lateral surface of the plate.

The “V”-like shape may define an angle comprised between 15° and 60°. The depth of the “V”-like shape, defined as the height of the “V”, between the lateral surface and the intersection of the two tangent planes, may be comprised between 2 mm and 15 mm, in particular in the range of 10 mm.

The number of said at least two guiding elements may be comprised between 2 and 12, in particular equal to 4.

Moreover, said at least two guide elements may be held secured together by means of at least one elastic element extending substantially vertically with respect to the vertical direction.

Each elastic element may include a sliding element provided with one end fastened to a guiding element, able to slide inside a fixed element, provided with one end fastened to another guiding element, the sliding and fixed elements being connected together by means of at least one tensile elastic return member.

In addition, said at least two guiding elements may be made of at least one electrically-insulating material.

Furthermore, another object of the invention, according to another aspect thereof, is a method for conditioning a stack of SOEC/SOFT-type solid-oxide cells operating at high temperature of an assembly as defined before, characterised in that it includes the step of guiding into a vertical stack at least part of the plate making up the stack by means of said at least two guiding elements.

### BRIEF DESCRIPTION OF THE DRAWINGS

The invention could be better understood upon reading the following detailed description of non-limiting examples of implementation of the latter, as well as upon examining the schematic and partial figures of the appended drawing, wherein:

FIG. 1 is a schematic view showing the operating principle of a high-temperature solid-oxide electrolyser (SOEC),

FIG. 2 is an exploded schematic view of a portion of a high-temperature solid-oxide electrolyser (SOEC) comprising interconnectors according to the prior art,

FIG. 3A and FIG. 3B show, schematically and partially, respectively according to a top view and according to a side view, a principle according to the prior art for guiding the plates of a SOEC/SOFC-type high-temperature stack,

FIG. 4A shows, according to a perspective view, an example of an assembly in accordance with the invention, including a high-temperature SOEC/SOFC-type stack and four guiding elements,

FIG. 4B is an enlarged view according to B1 of [FIG. 4A],

FIG. 5 show a detail of making of a “V”-like shaped notch on the plates of the stack of FIG. 4A,

FIG. 6 is a detail view of the fastening device on the lower support plate for the stack of FIG. 4A,

FIG. 7 is a top view of FIG. 6,

FIG. 8 shows, in front view, the lower end plate of the stack of FIG. 4A,

FIG. 9 shows, according to a perspective view, a guiding element of the assembly of FIG. 4A,

FIG. 10 shows, according to a perspective view, a variant of a guiding element,

FIG. 11 shows, according to a perspective view, another example of an assembly in accordance with the invention including a high-temperature SOEC/SOFC-type stack and four guiding elements, wherein elastic elements are used,

FIG. 12 is a top view of FIG. 11,

FIG. 13A shows, according to a perspective view, an example of an elastic element of the assembly of FIG. 11,

FIG. 13B is a view according to B2 of FIG. 13A,

FIG. 14 illustrates, in perspective, stacking of the lower end plate of a stack of an assembly in accordance with the invention,

FIG. 15 is a detail view of FIG. 14 showing a fastening device,

FIG. 16 and FIG. 17 are detail views showing details of making of the fastening device,

FIG. 18 shows, according to a perspective view, a variant of a guiding element,

FIG. 19A shows, according to a perspective view, an upper support plate and four guiding elements,

FIG. 19B is an enlarged view according to B3 of FIG. 19A illustrating a fastening device,

FIG. 20A shows, according to a perspective view, a variant of an assembly in accordance with the invention including a high-temperature SOEC/SOFC-type stack and four guiding elements, using the upper support plate of FIG. 19A, and

FIG. 20B is an enlarged view according to B4 of FIG. 20A.

In all these figures, identical references may designate identical or similar elements.

In addition, the different portions shown in the figures are not necessarily plotted according to a uniform scale, to make the figures more readable.

DETAILED DISCLOSURE OF PARTICULAR EMBODIMENTS

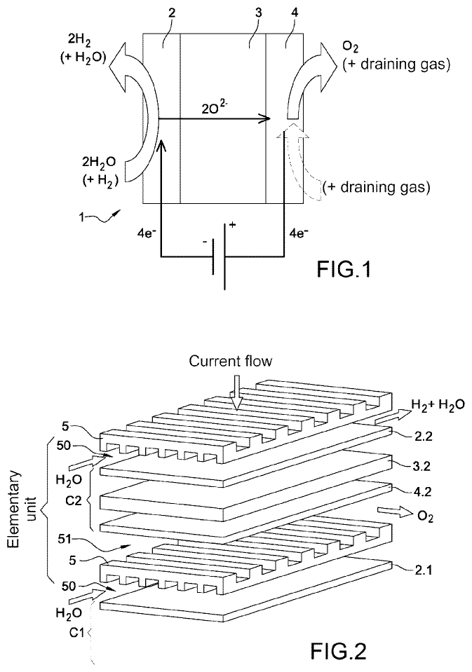

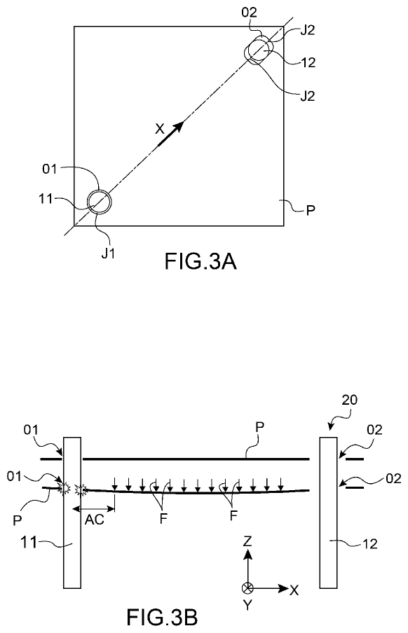

FIGS. 1 to 3 have already been described before in the part relating to the prior art and to the technical context of the invention. It is specified that, for FIGS. 1 and 2, the symbols and the arrows for steam supply H₂O, for distribution and recovery of dihydrogen H₂, oxygen O₂, air and electric current, are shown for clarity and accuracy purposes, to illustrate the operation of the shown devices.

Furthermore, it should be noted that all of the constituents (anode/electrolyte/cathode) of a given electrochemical cell are preferably ceramics. Moreover, the operating temperature of a SOEC/SOFC-type high-temperature stack is typically comprised between 600 and 1,000° C.

In addition, any terms “upper”, “lower”, “horizontal” and “vertical” should be understood herein according to the common direction of orientation of a SOEC/SOFC-type stack when in its use configuration.

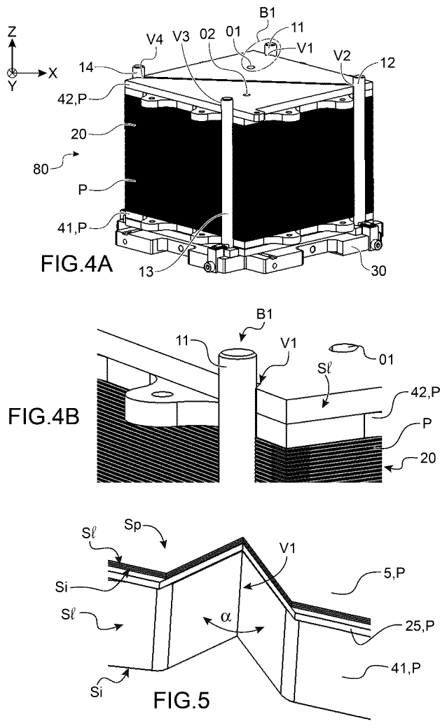

FIGS. 4A to 20B allow illustrating the principle of outer guidance in accordance with the invention. In comparison with the principle of inner guidance of a stack, outer guidance has several advantages, and in particular for stacks with large heights. Located at the periphery, it could simplify the integration of cooling circuit passages placed at the corners of the stacks. In addition, the elimination of the inner guiding columns could also allow considering conditioning several sub-stacks under the same press more easily. Indeed, in a configuration integrating an inner guidance, once the stack has a undergone a height reduction, the columns protrude from the upper end plate preventing placement of a second stack over the upper end plate. For this reason, this inner guidance type does not allow the simultaneous manufacture of an assembly of several independent sub-stacks stacked on top of one another on the same bench. Moreover, one of the advantages of outer guidance according to the invention may also be the easy disassembly of the guiding columns which enables a reduction in the size of the stack compared to inner guidances and which clears the way for new possibilities of the geometric configuration or of the inner design of the stacks.

Thus, FIGS. 4A to 9 relate to a first embodiment of an assembly 80 in accordance with the invention comprising a stack 20 of SOEC/SOFC-type solid-oxide cells operating at high temperature.

This stack 20 consists of a plurality of plates P stacked on top of one another according to a vertical direction Z which is perpendicular to each of the plates P extending in horizontal planes parallel to the horizontal plane with the axes X and Y, as shown in FIG. 4A.

The stack 20 includes a plurality of electrochemical cells C1, C2 as defined before, herein for example 100 electrochemical cells, each formed by a cathode, an anode and an electrolyte interposed between the cathode and the anode, and a plurality of interconnectors 5 each arranged between two adjacent electrochemical cells C1, C2. In addition, the stack 20 includes an upper end plate 42 and a lower end plate 41, between which the plurality of electrochemical cells C1, C2 and the plurality of interconnectors 5 are sandwiched.

For example, a plate P of the stack 20 may be formed by an electrochemical cell C1, C2, an interconnector 5, the upper end plate 42, the lower end plate 41 or an insulator plate 25, for example made of mica, as shown in FIG. 5. Each of these plates P includes an upper surface Sp, a lower surface S1 and an outer lateral surface SI, shown in particular in FIG. 5. The outer lateral surface SI connects the upper Sp and lower Si surfaces.

Moreover, to achieve the outer guidance of the plates P into a vertical stack, the assembly 80 in accordance with the invention includes four guiding elements 11, 12, 13, 14, herein in the form of guiding columns. In particular, the number of guiding elements may be comprised between 2 and 12, preferably equal to 4.

These guiding columns 11, 12, 13 and 14 extend vertically according to the vertical direction Z bearing against the outer lateral surface SI of each plate P. Thus, the outer guidance is achieved by bearing on the outer face(s) of the stack.

In this example, each guiding column 11, 12, 13, 14 has a cylindrical shape and a circular shape in cross-section with respect to the vertical direction Z, as shown for example in FIG. 9. Alternatively, any other shape could be possible, in particular square or rectangular.

In addition, each plate P of the stack 20 is substantially square shaped with a lateral surface SI thus comprising four lateral faces. On each lateral face, a notch V1, V2, V3, V4 is formed in which a guiding column 11, 12, 13, 14 bears.

Advantageously, these four notches V1, V2, V3 and V4 are in the form of a “V” obtained by formation of two planes tangent on the lateral face. Alternatively, any other shape is possible, in particular circular or oval. It is also possible to have no notch formed on the plates P.

Thus, the outer guidance is herein achieved by cylindrical columns on planar edges type supports. Specifically, guidance is achieved by forming a support between a cylindrical face of one column and two tangent planes obtained by machining a “V”-like notch.

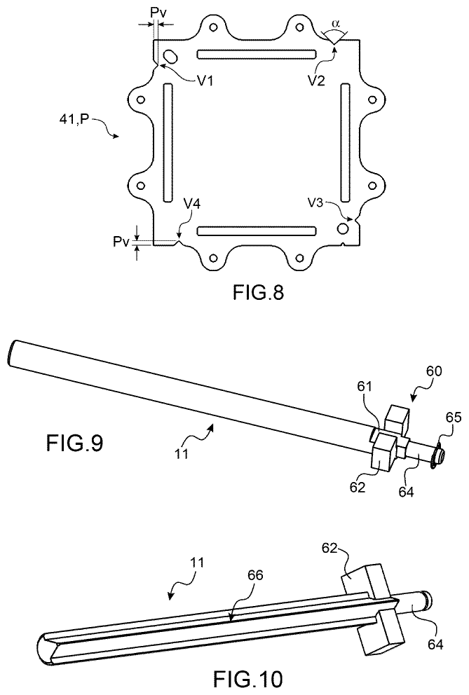

As shown in FIGS. 5 and 8 in particular, each notch V1, V2, V3, V4 has a “V”-like shape which defines an aperture angle α comprised between 15° and 60°. Advantageously, the same notch type is formed on all of the plates P making up the stack 20. The number of notches used herein is 4 to guarantee guidance by an equivalent number of columns 11, 12, 13, 14. Alternatively, it may be comprised between 2 and 12. Moreover, the depth Pv of the “V”-like shape of each notch V1, V2, V3, V4, defined as the height of the “V”, between the lateral surface SI and the intersection of the two tangent planes, as shown in FIG. 8, is comprised between 2 mm and 15 mm, in particular in the range of 10 mm. This depth Pv can be adjusted according to the specific geometric constraints of the stack 20 and the desired guiding height. Also, depending on the selected depth Pv, several diameters of guiding columns may be considered while preserving a geometry allowing ensuring a tangential support between the cylindrical surface and the support planes formed by the “V” machined on the edges of the plates P. The position of the notches V1, V2, V3, V4 may be selected freely and adapt to the geometry of the plates P, provided that each of the notches is preferably associated with another notch placed substantially diametrically (or diagonally) opposite thereto.

It should be noted that a different shape of a “V” may be used for all or part of the notches V1, V2, V3, V4, in particular a circular or oval shape. In particular, a circular shape may allow having one single contact point so as to limit frictions with a “V”-like shape. Advantageously, the diameter of the notch, or its largest transverse direction, should further be larger than that of a guiding column.

Moreover, in order to guarantee enough bearing contact while allowing for coplanar movements of the plates P due to expansions during the phase of manufacturing the sealing vitroceramic, it is advantageous to fasten the guiding columns 11, 12, 13, 14 by means of a fastening device 50 to a lower support plate 30 and/or an upper support plate 31.

More specifically, in order to ensure guidance with a continuous support of the columns 11, 12, 13, 14 on the plates P without generating considerable stresses which could result in an off-centring of these, the columns are mounted on at least one support plate 30, 31 with an interface allowing ensuring the following mechanical functions: preserving the perpendicularity of the columns and vertical blocking thereof; the translation of the columns in the axis of movement of the faces of the stack; and the compression of the elastic element bearing on the columns.

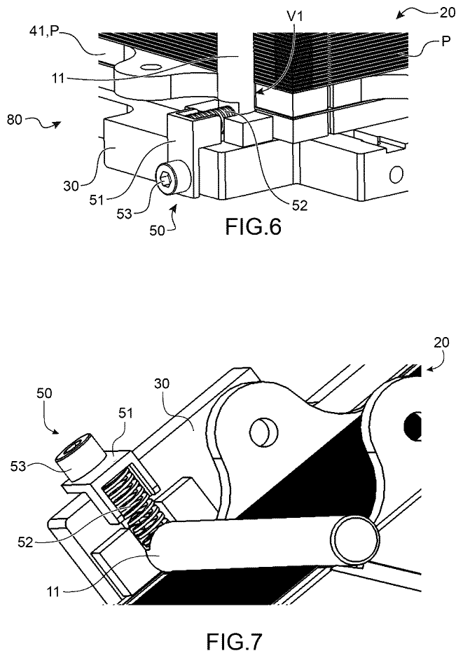

In this example of FIGS. 4A to 9, a fastening device 50 is provided at the root of each guiding column 11, 12, 13, 14 to ensure mechanical support of the column on the stack 20 while integrating an elastic element, as shown in FIGS. 6 and 7 in particular. Hence, each fastening device 50 is fastened to the lower support plate 30 herein corresponding to the support plate of the manufacturing bench, namely the manifold.

Thus, each fastening device 50 comprises a fastening base 51 or heel, which is secured to the lower support plate 30, a compression elastic return member 52, herein a compression spring (or alternatively a set of washers), one end of which is in contact with the guiding column 11, 12, 13, 14 and the other end is in contact with the fastening base 51, and a fastening screw 53 mounted on the base 51, this fastening screw 53 enabling fastening and adjustment.

Most of the vertical shrinkage movement of the stack 20 observed on the stacks during the phase of forming the vitroceramic takes place in a temperature range comprised between 650° C. and 750° C. These temperatures, which are lower than the maximum temperature reached during the manufacturing cycle, allow considering the use of metal compression springs 52 preserving mechanical characteristics that are still enough to ensure a compression force. Thus, the compression springs 52 may be made for example of Nickel-based metal superalloys, for example of Inconel® 718 or 750, used industrially for manufacturing springs for applications at very high temperatures. In addition, the drastic decline in the elastic and mechanical properties of the constituent material of the spring for temperatures higher than 750° C. does not pose any problem per se, to the extent that the movements of the stack 20 beyond this temperature are low, thereby lowering guidance constraints. The compression springs 52 may be of the meltable type intended for one single use ensuring their mechanical function for temperatures lower than 750° C. Thus, they may be made of any material preserving good elastic properties and having a low creeping at these temperatures. For example, the compression springs 52 may also be made of Haynes® 230®-type metal superalloys, or of ceramic, for example obtained by additive manufacturing.

Furthermore for each guiding column 11, 12, 13, 14 is embedded and fastened in the lower support plate 30, or support plate of the manufacturing bench, and possibly also in the lower end plate 41, the column is also modified at its root.

Thus, as shown in particular in FIG. 9, each guiding element 11, 12, 13, 14 includes a support device 60 cooperating with the fastening device 50. This support device 60 includes a support plane 61, with a flat shape, to enable support of the compression spring 52, and a support base 62 which comes into contact with the lower support plate 30. Furthermore, the lower end of the column corresponds to a lower guiding stud 64 on which a circlip-type blocking ring 65 is provided.

For this assembly type, the position and the relative clearances between the columns 11, 12, 13, 14 and the plates P of the stack 20 should be sized while considering the expansions of the different elements of the assembly. Preferably, the material of a guiding column may consist of a material having the same coefficient of expansion as the stack 20, namely for example a ferritic steel, or example of the VDM® Crofer or K41® type, and preferably also of the same material as the lower support plate 30 or support plate of the manufacturing bench.

Advantageously, each guiding column 11, 12, 13, 14 has a contact point that is as small as possible to limit frictions. To ensure this contact point, columns with a circular-shaped cross-section, like in FIG. 9, may be selected. Alternatively, as illustrated in FIG. 10, triangular-shaped, or in this case semi-triangular and semi-circular shaped, columns may be used. In this case, the column has a support edge 66 which comes directly into contact with the lateral surface SI of a plate P, without any need to form a notch on the latter.

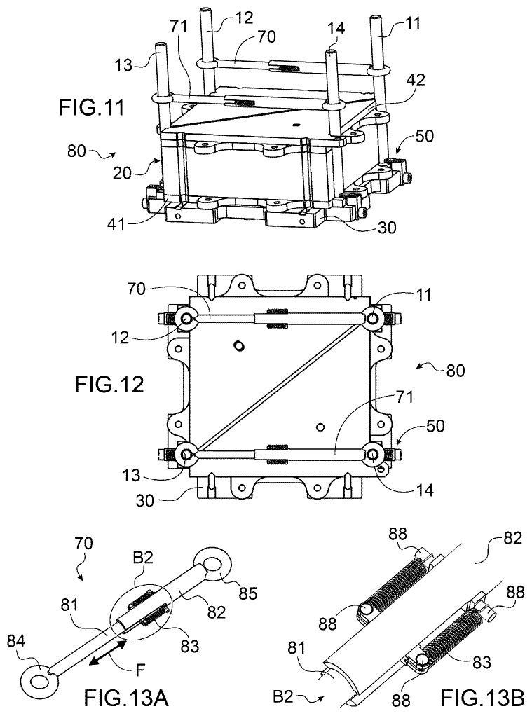

Moreover, guidance may be achieved such that the columns 11, 12, 13, 14 are held in place using an additional elastic element, as illustrated in FIGS. 11 to 13B.

Thus, two guiding columns 11, 12 and 13, 14 may be held secured together by means of an elastic element, respectively 70 and 71 extending transversely with respect to the vertical direction Z.

These elastic elements 70 and 71 may be selected so as t preserve their elasticity as high as possible and at least up to 750° C.

Thus, each elastic element 70, 71 includes a sliding bar 81, according to the double arrow F visible in FIG. 13A, provided with one end 84 in the form of a mounting ring fastened to a column 12 or 13, and able to slide inside a fixed bar 82, provided with one end 85 in the form of a mounting ring also fastened to another column 11 or 14.

These sliding 81 and fixed 82 bars are connected together by means of tensile springs 83 mounted on pins 88 of these bars 81, 82.

Advantageously, these elastic elements 70, 71 allow keeping the columns parallel to one another during stacking. They allow avoiding or limiting any deviations and deformations of the columns during movements of the stack. They may be of the fusible type and made of the same high-temperature material as the columns.

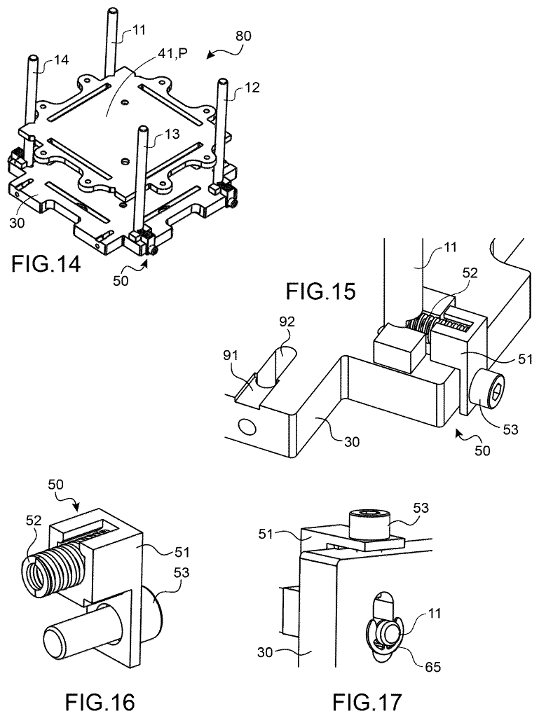

FIGS. 14 to 17 illustrate the stack of the lower end plate 41 on the lower support plate 30 and fastening of the columns 11, 12, 13 and 14 on the lower support plate 30 by means of four fastening devices 50.

Complementarily to what has been described before, one could see in FIG. 15 that the lower support plate 30 includes a counterbore 92 and a flat surface 91 to enable guidance of the column and of the base 51 or heel. The base 51 ensures perpendicularity of the column and the guiding stud 64, machined so as to receive the circlip 65 (or any other equivalent, for example a pin or a clamping ring), is inserted into the counterbore 92 to ensure vertical blocking, protruding beyond the thickness of the plate 30.

This mounting as illustrated in FIGS. 14 to 17 allows centring the stack 20 on the bench so as to enable an initial set-up of the mounting in the axis of the applied force. Perpendicularity is ensured by the base 62 and blocking by means of the ring65 mounted on the end of the column that protrudes from the plate 30. The guided translational movement of the column is ensured by sliding of the base 62 in an oblong slot, or counterbore 92, machined in the plate 30. Holding and compression of the compression spring 52 is ensured by the fastening base 51 whose position is laterally blocked by the flat surface 91. The screw 53 allows adjusting the compression level of the spring 52.

The assembly 80 is intended for the assembly of a stack 20 to ensure guidance during a thermal cycle for forming the vitroceramic seal. To enable use thereof in the context of conditioning cycles including tensioning of the stack, each column 11, 12, 13, 14 may be made of at least one electrically-insulating material to avoid short-circuiting of the different stages of the stack. Any insulating material may be used, like a ceramic material, for example alumina, Macor®, inter alia, or a metal material that becomes insulating after heating, such as aluminoforming, as well as any material that is initially conductive but covered with an insulating layer.

Preferably, each guiding column 11, 12, 13, 14 may be made of VDM® Crofer to allow having coefficients of thermal expansion identical to those of the stack 20 and may be covered with an insulating material layer withstanding high temperatures, for example yttriated zirconia.

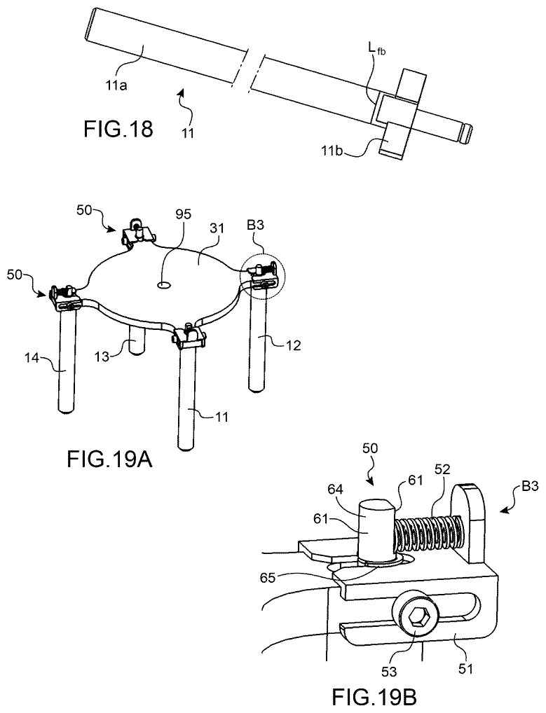

Alternatively, each column 11, 12, 13, 14 may also be made into two portions as illustrated by FIG. 18. Thus, for example, the column 11 may include a first portion 11a made for example of alumina and a second metal portion 11b, the two portions being connected by a threaded, welded or brazed connection Lfb.

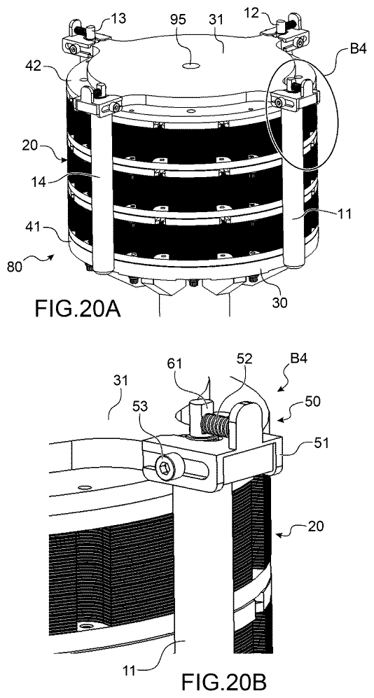

Moreover, the previously-described principle of fastening on the lower support plate 30 may also be applied to an upper support plate 31 as illustrated by FIGS. 19A to 20B for a cylindrical-type stack 20 geometry.

The upper support plate 31 includes a central base 95 of the support ball joint, and four fastening devices 50 allowing fastening the four guiding columns 11, 12, 13 and 14.

In this cylindrical geometry of the stack 20, the columns may bear directly on the lateral surfaces SI of the plates P without requiring the presence of notches. With this support type, larger column diameters may also be used. It should be noted that this configuration type, placed on top of the stack 20 rather than secured to the lower support plate 30, may also adapt to stacks with straight edges, as described before.

Of course, the invention is not limited to the embodiments that have just been described. Various modifications may be made thereto by a person skilled in the art.

1-15. (canceled)

16. An assembly including:
a stack of SOEC/SOFC-type solid-oxide cells operating at high temperature, consisting of a plurality of plates stacked on top of one another according to a vertical direction substantially perpendicular to each horizontal plane of extent of each plate, each plate including an upper surface, a lower surface and an outer lateral surface,
the plurality of plates comprising:
a plurality of electrochemical cells each formed by a cathode, an anode and an electrolyte interposed between the cathode and the anode, and a plurality of interconnectors each arranged between two adjacent ones of the plurality of electrochemical cells,
an upper end plate and a lower end plate, between which the plurality of electrochemical cells and the plurality of interconnectors are sandwiched, and
at least two guiding elements configured to provide guidance into a vertical stack of at least part of the plates of the stack,
wherein the at least two guiding elements extend vertically according to the vertical direction bearing against the outer lateral surface of each plate) of the at least part of the plates, and
wherein the at least two guiding elements are fastened using a fastening device to a lower support plate on which the stack is placed and/or to an upper support plate under which the stack is placed, and the fastening device includes a fastening base secured to the lower support plate and/or to the upper support plate, a compressive elastic return member, one end of which is in contact with one of the at least two guiding elements and another end is in contact with the fastening base, and a fastening screw mounted on the base.

17. The assembly according to claim 16, wherein the compressive elastic return member is made of a metal alloy or made of ceramic.

18. The assembly according to claim 16, wherein each of the at least two guiding elements includes a support device cooperating with the fastening device, including at least one support plane of the compressive elastic return member and a support base in contact with the lower support plate and/or the upper support plate.

19. The assembly according to claim 16, wherein the at least two guiding elements have at least partially a substantially cylindrical shape and having, in cross-section with respect to the vertical direction, a substantially circular, triangular, triangular and semi-circular, square and/or rectangular shape.

20. The assembly according to claim 16, wherein each plate of the at least part of the plates includes at least two notches formed over the outer lateral surface of the plate in which the at least two guiding elements bear.

21. The assembly according to claim 20, wherein each notch of at least part of the notches has a “V”-like shape obtained by forming two planes tangent on the outer lateral surface of the plate.

22. The assembly according to claim 21, wherein the “V”-like shape defines an angle comprised between 15° and 60°.

23. The assembly according to claim 21, wherein a depth of the “V”-like shape, defined as a height of the “V”, between the outer lateral surface and an intersection of the two tangent planes, is comprised between 2 mm and 15 mm.

24. The assembly according to claim 16, wherein a number of said at least two guiding elements is comprised between 2 and 12.

25. The assembly according to claim 16, wherein the at least two guide elements are held secured together using at least one elastic element extending substantially transversally with respect to the vertical direction.

26. The assembly according to claim 25, wherein each elastic element includes a sliding element provided with one end fastened to one of the at least two guiding elements configured to slide inside a fixed element, and provided with another end fastened to another one of the at least two guiding elements, the sliding and fixed elements being connected together using at least one tensile elastic return member.

27. The assembly according to claim 16, wherein the at least two guiding elements are made of at least one electrically-insulating material.

28. The assembly according to claim 16, wherein the compressive elastic return member is made of a metal superalloy.

29. The assembly according to claim 16, wherein the compressive elastic return member is made of a nickel-based alloy.

30. The assembly according to claim 16, wherein the compressive elastic return member is made by additive manufacturing.

31. The assembly according to claim 16, wherein each plate of the at least part of the plates includes at least circular, oval or “V”-like shaped two notches formed over the outer lateral surface of the plate in which the at least two guiding elements bear.

32. The assembly according to claim 23, wherein a depth of the “V”-like shape is in a range of 10 mm.

33. The assembly according to claim 16, wherein a number of said at least two guiding elements is equal to 4.

34. A method for conditioning a stack of SOEC/SOFT-type solid-oxide cells operating at high temperature of an assembly according to claim 16, comprising:
guiding into the stack at least part of the plate making up the stack using the at least two guiding elements.
